(19) United States
(12) Patent Application Publication
(10) Pub. No.: US 2017/0361925 A1
(43) Pub. Date: Dec. 21, 2017

(54) AUXILIARY ROTATING STRUCTURE AND TIRE ASSEMBLY THEREWITH

(71) Applicant: Wei-Lin Pao, Taipei City (TW)

(72) Inventor: Wei-Lin Pao, Taipei City (TW)

(21) Appl. No.: 15/182,623

(22) Filed: Jun. 15, 2016

(51) Int. Cl. B64C 25/40; B60C 19/00; B64C 25/36

(52) U.S. Cl. CPC B64C 25/40; B64C 25/36; B60C 19/00; B60C 2200/02

(57) ABSTRACT

An auxiliary rotating structure adapted for a tire of an aircraft includes a first side wall and a second side wall. The first side wall is fixed on a wall of the tire and rotates along with the tire. A side of the second side wall is connected to a side of the first side wall to form a chamber between the first side wall and the second side wall. An opening is formed between the other side of the first side wall and the other side of the second side wall and communicated with the chamber. The second side wall is made of resilient material. When the auxiliary rotating structure is located at a lower side of the tire, an air flow passes through the opening into the chamber to generate a first torque along a first rotary direction for rotating the tire.

### BACKGROUND OF THE INVENTION

### 1. Field of the Invention

The present invention relates to an auxiliary rotating structure and a tire assembly therewith, and more particularly, to an auxiliary rotating structure and a tire assembly therewith capable of preventing a serious wear caused by a high speed touchdown of an aircraft, so as to extend service life of the tire assembly.

### 2. Description of the Prior Art

A tire of an aircraft is for absorbing an impact force and providing a frictional force when the aircraft is landing. Especially, when the tire contacts the ground surface during the landing of the aircraft, the frictional force drives the tire to start rotating, so that the tire is worn by the frictional force seriously at this moment, which reduces service life of the tire. Therefore, the tire should be inspected and replaced by a new one within a short period, which increases cost of replacement and maintenance.

### SUMMARY OF THE INVENTION

The present invention is to provide an auxiliary rotating structure and a tire assembly therewith for solving the aforementioned drawbacks.

According to the claimed invention, an auxiliary rotating structure adapted for a tire of an aircraft includes a first side wall and a second side wall. The first side wall is fixed on a wall of the tire and rotates along with the tire. A side of the second side wall is connected to a side of the first side wall to form a chamber between the first side wall and the second side wall. An opening is formed between the other side of the first side wall and the other side of the second side wall and communicated with the chamber. The second side wall is made of resilient material. When the auxiliary rotating structure is located at a lower side of the tire, the opening faces windward with respect to an air flow, so that the air flow passes through the opening into the chamber to generate a first torque along a first rotary direction for rotating the tire, and when the auxiliary rotating structure is located at an upper side of the tire, the opening faces leeward with respect to the air flow, so that the air flow flows through the second side wall to deform the second side wall to be attached on the first side wall for generating a second torque along a second rotary direction opposite to the first rotary direction and less than the first torque.

According to the claimed invention, the side of the first side wall and the side of the second side wall are formed in a streamlined shape.

According to the claimed invention, the other side of the second side wall is formed in a curved shape.

According to the claimed invention, a tire assembly includes tire having a wall and at least one auxiliary rotating structure. The at least one auxiliary rotating structure includes a first side wall and a second side wall. The first side wall is fixed on the wall and rotates along with the tire. A side of the second side wall is connected to a side of the first side wall to form a chamber between the first side wall and the second side wall. An opening is formed between the other side of the first side wall and the other side of the second side wall and communicated with the chamber. The second side wall is made of resilient material. When the at least one auxiliary rotating structure is located at a lower side of the tire, the opening faces windward with respect to an air flow, so that the air flow passes through the opening into the chamber to generate a first torque along a first rotary direction for rotating the tire, when the auxiliary rotating structure is located at an upper side of the tire, the opening faces leeward with respect to the air flow, so that the air flow flows through the second side wall to deform the second side wall to be attached on the first side wall for generating a second torque along a second rotary direction opposite to the first rotary direction and less than the first torque.

According to the claimed invention, the side of the first side wall and the side of the second side wall are formed in a streamlined shape.

According to the claimed invention, the other side of the second side wall is formed in a curved shape.

According to the claimed invention, the wall and the at least one auxiliary rotating structure are integrally formed.

According to the claimed invention, the at least one auxiliary rotating structure comprises four auxiliary rotating structures disposed on the wall at equal intervals.

In summary, the present invention utilizes the first side wall and the second side wall on the wall of the tire for forming the chamber and the opening of the auxiliary rotating structure. Therefore, when the auxiliary rotating structure is located at the lower side of the tire, the opening faces windward with respect to the air flow, so that the air flow passes through the opening into the chamber to generate the first torque along the first rotary direction for rotating the tire assembly, which reduces the relative speed between the tire and the ground surface and relieves wear of the tire, so as to extend the service life of the tire. Furthermore, when the auxiliary rotating structure is located at the upper side of the tire assembly, the opening faces leeward with respect to the air flow, so that the air flow flows through the second side wall to deform the second side wall to be attached on the first side wall for generating the second torque along the second rotary direction opposite to the first rotary direction and less than the first torque, which facilitates the tire assembly to rotate in the first rotary direction without air resistance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an aircraft with a tire assembly according to an embodiment of the present invention.

FIG. 2 is a diagram of the tire assembly according to the embodiment of the present invention.

FIG. 3 is a diagram of an auxiliary rotating structure according to the embodiment of the present invention.

FIG. 4 is a diagram of the tire assembly as the aircraft is landing according to the embodiment of the present invention.

### DETAILED DESCRIPTION

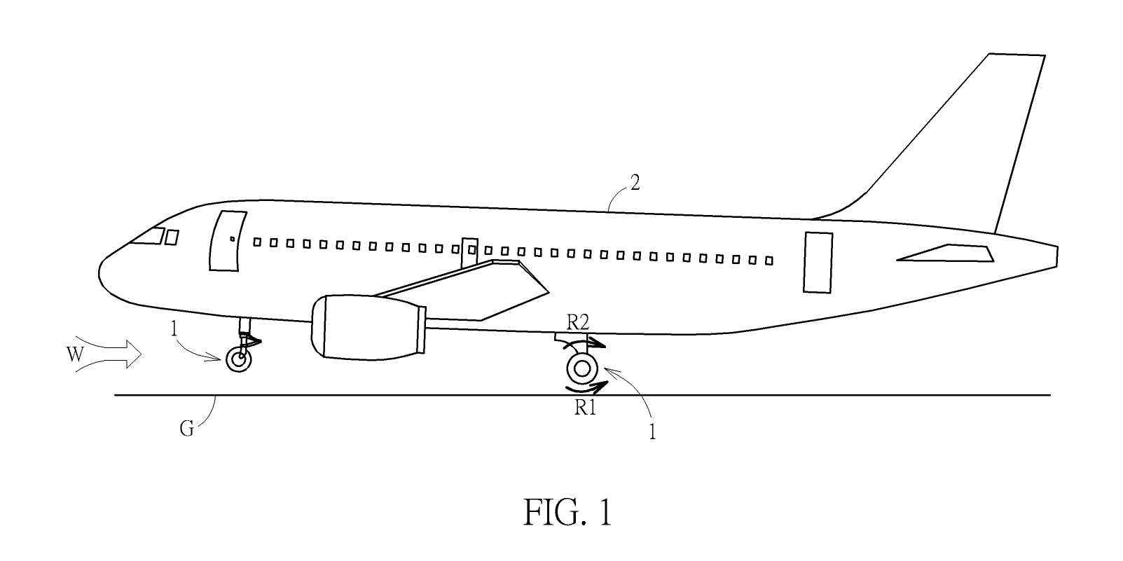

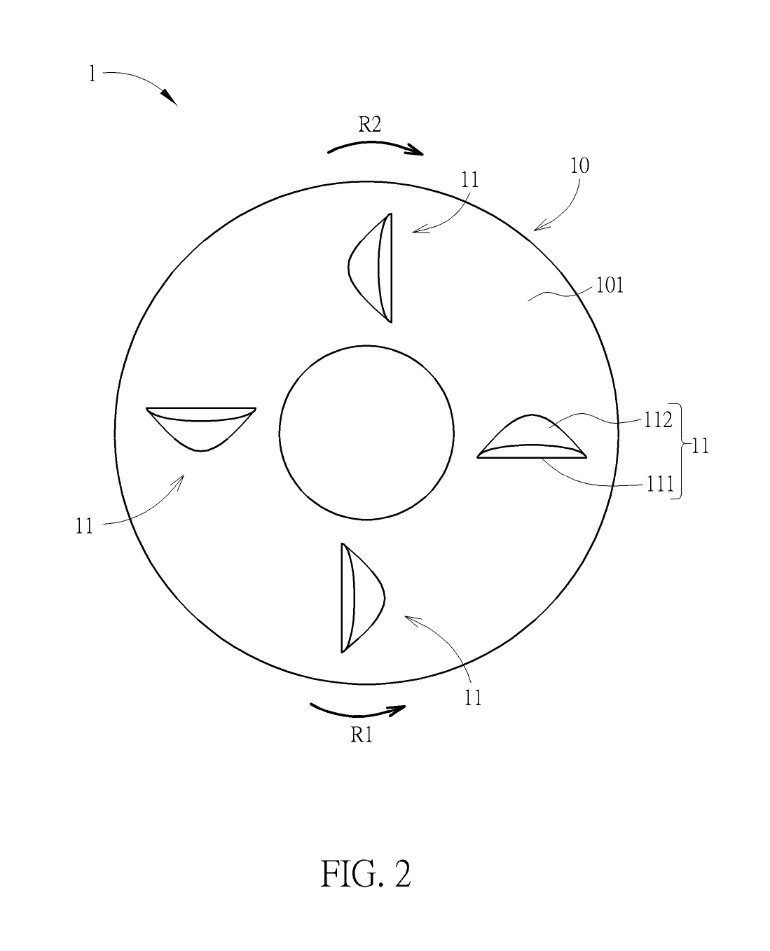

Please refer to FIG. 1 and FIG. 2. FIG. 1 is a schematic diagram of an aircraft 2 with a tire assembly 1 according to an embodiment of the present invention. FIG. 2 is a diagram of the tire assembly 1 according to the embodiment of the present invention. As shown in FIG. 1, the tire assembly 1 is installed on the aircraft 2 and capable of being driven to rotate for reducing a frictional force between the tire assembly 1 and a ground surface Gas the aircraft 2 is landing. As shown in FIG. 2, the tire assembly 1 includes a tire 10 having a wall 101, and four auxiliary rotating structures 11. The wall 101 can be a surface on a tire body or a hub of the tire 10. The four auxiliary rotating structures 11 are symmetrically disposed on the wall 101 of the tire 10 at equal intervals. In other words, an included angle between two adjacent auxiliary rotating structures 11 is 90 degrees substantially. However, the number and configuration of the auxiliary rotating structure 11 are not limited to this embodiment. For example, the tire assembly 1 can includes two auxiliary rotating structures 11 diagonally disposed on the wall 101 and opposite to each other.

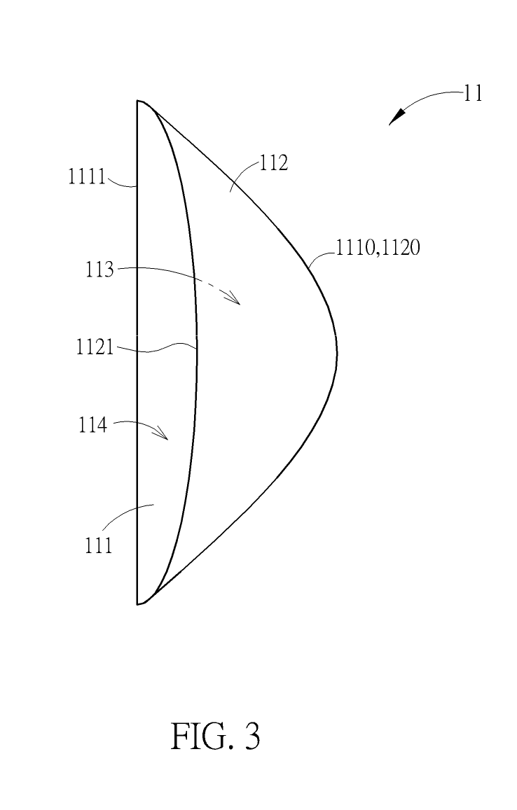

Please refer to FIG. 2 and FIG. 3. FIG. 3 is a diagram of the auxiliary rotating structure 11 according to the embodiment of the present invention. As shown in FIG. 2 and FIG. 3, the rotating structure includes a first side wall 111 and a second side wall 112. The first side wall 111 is fixed on the wall 101 of the tire 10 and rotates along with the tire 10. A side 1120 of the second side wall 112 is connected to a side 1110 of the first side wall 111 to form a chamber 113 between the first side wall 111 and the second side wall 112. An opening 114 is formed between the other side 1111 of the first side wall 111 and the other side 1121 of the second side wall 112 and communicated with the chamber 113. In other words, the second side wall 112 is connected to the first side wall 111 by the following ways. The opening 114 is located at a side of the auxiliary rotating structure 11 and communicated with the chamber 113 between the first side wall 111 and the second side wall 112. Besides, at the other side of the auxiliary rotating structure 11, an edge of the other side 1121 of the second side wall 112 is connected to the first wall 111 all the way (without any opening). Furthermore, in this embodiment, the second side wall 112 can be made of resilient material, so as to be deformed easily. The side 1110 of the first side wall 111 and the side 1120 of the second side wall 112 can be formed in a streamlined shape, and the other side 1121 of the second side wall 112 can be formed in a curved shape. However, the shapes of the first side wall 111 and the side of the second side wall 112 are not limited to this embodiment.

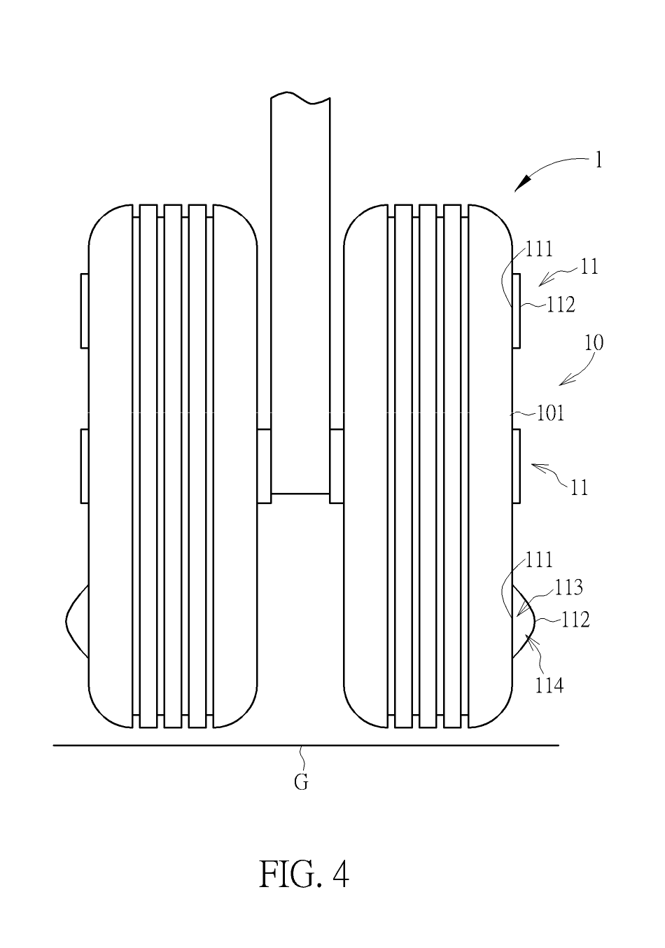

Please refer to FIG. 1 to FIG. 4. FIG. 4 is a diagram of the tire assembly 1 as the aircraft 2 is landing according to the embodiment of the present invention. As shown in FIG. 1 to FIG. 4, when the aircraft 2 is landing, the tire assembly 1 is located at a landing position. The opening 114 of one of the four auxiliary rotating structures 11 located at a lower side of the wall 101 of the tire 10 faces windward with respect to an air flow W. The curved-shaped side 1121 of the second side wall 112 allows the air flow W to pass through the opening 114 into the chamber 113 of the auxiliary rotating structures 11 located at the lower side of the wall 101 easily, so as to generate a first torque along a first rotary direction R1 for rotating the tire assembly 1. At this time, the opening 114 of another one of the four auxiliary rotating structures 11 located at an upper side of the wall 101 faces leeward with respect to the air flow W. The streamlined-shaped sides 1110, 1120 of the first side wall 111 and the second side wall 112 of the auxiliary rotating structures 11 located at the upper side of the wall 101 allow the air flow W to smoothly flow through the second side wall 112, so as to deform the second side wall 112 to be attached on the first side wall 111 for generating a second torque along a second rotary direction R2 opposite to the first rotary direction R1 and less than the first torque. Therefore, the tire assembly 1 can be driven to rotate along the first rotary direction R1 (forward), due to a resultant torque of the first torque and the second torque. As for the other two auxiliary rotating structures 11 located at left and right sides of the wall 101 of the tire 10, since the side 1110 of the first side wall 111 and the side 1120 of the second side wall 112 are formed in a streamlined shape, the air flow W can flow through the second side walls 112 of the auxiliary rotating structures 11 smoothly. Therefore, the second side walls 112 of the other two auxiliary rotating structures 11 located at the left and right sides of the wall 101 of the tire 10 are driven to be deformed and attached on the first side walls 111.

In other words, the auxiliary rotating structure 11 located at the lower side of the wall 101 receives the air flow W to generate the first torque for driving the tire assembly 1 to rotate in the first rotary direction R1. Except for the auxiliary rotating structure 11 located at the lower side of the wall 101, other three auxiliary rotating structures 11 are collapsed by the air flow W, so as to generate the second torque along the second direction R2 and less than the first torque. The tire assembly 1 is driven to rotate forwardly before landing, so that a relative speed between the tire 10 and the ground surface G can be reduced for reducing the frictional force between the tire 10 and the ground surface G, which extends the service life of the tire 10 of the tire assembly 1.

In contrast to the prior art, the present invention utilizes the first side wall and the second side wall on the wall of the tire for forming the chamber and the opening of the auxiliary rotating structure. Therefore, when the auxiliary rotating structure is located at the lower side of the tire, the opening faces windward with respect to the air flow, so that the air flow passes through the opening into the chamber to generate the first torque along the first rotary direction for rotating the tire assembly, which reduces the relative speed between the tire and the ground surface and relieves wear of the tire, so as to extend the service life of the tire. Furthermore, when the auxiliary rotating structure is located at the upper side of the tire assembly, the opening faces leeward with respect to the air flow, so that the air flow flows through the second side wall to deform the second side wall to be attached on the first side wall for generating the second torque along the second rotary direction opposite to the first rotary direction and less than the first torque, which facilitates the tire assembly to rotate in the first rotary direction without air resistance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An auxiliary rotating structure adapted for a tire of an aircraft, the auxiliary rotating structure comprising:
a first side wall fixed on a wall of the tire and rotating along with the tire; and
a second side wall, a side of the second side wall being connected to a side of the first side wall to form a chamber between the first side wall and the second side wall, an opening being formed between the other side of the first side wall and the other side of the second side wall and communicated with the chamber, the second side wall being made of resilient material;
wherein when the auxiliary rotating structure is located at a lower side of the tire, the opening faces windward with respect to an air flow, so that the air flow passes through the opening into the chamber to generate a first torque along a first rotary direction for rotating the tire, and when the auxiliary rotating structure is located at an upper side of the tire, the opening faces leeward with respect to the air flow, so that the air flow flows through the second side wall to deform the second side wall to be attached on the first side wall for generating a second torque along a second rotary direction opposite to the first rotary direction and less than the first torque.

2. The auxiliary rotating structure of claim 1, wherein the side of the first side wall and the side of the second side wall are formed in a streamlined shape.

3. The auxiliary rotating structure of claim 1, wherein the other side of the second side wall is formed in a curved shape.

4. A tire assembly comprising:
a tire comprising a wall; and
at least one auxiliary rotating structure comprising:
a first side wall fixed on the wall and rotating along with the tire; and
a second side wall, a side of the second side wall being connected to a side of the first side wall to forma chamber between the first side wall and the second side wall, an opening being formed between the other side of the first side wall and the other side of the second side wall and communicated with the chamber, the second side wall being made of resilient material;
wherein when the at least one auxiliary rotating structure is located at a lower side of the tire, the opening faces windward with respect to an air flow, so that the air flow passes through the opening into the chamber to generate a first torque along a first rotary direction for rotating the tire, when the auxiliary rotating structure is located at an upper side of the tire, the opening faces leeward with respect to the air flow, so that the air flow flows through the second side wall to deform the second side wall to be attached on the first side wall for generating a second torque along a second rotary direction opposite to the first rotary direction and less than the first torque.

5. The tire assembly of claim 4, wherein the side of the first side wall and the side of the second side wall are formed in a streamlined shape.

6. The tire assembly of claim 4, wherein the other side of the second side wall is formed in a curved shape.

7. The tire assembly of claim 4, wherein the wall and the at least one auxiliary rotating structure are integrally formed.

8. The tire assembly of claim 4, wherein the at least one auxiliary rotating structure comprises four auxiliary rotating structures disposed on the wall at equal intervals.
